(19) United States
(12) Patent Application Publication
(10) Pub. No.: US 2003/0094710 A1
(43) Pub. Date: May 22, 2003

(54) Entrainment resistant evaporative cooler pad frame

(76) Inventor: Gary S. Jouas, Phoenix, AZ (US)

Correspondence Address: FENNEMORE CRAIG, 3003 NORTH CENTRAL AVENUE, SUITE 2600, PHOENIX, AZ, 85012, US

(21) Appl. No.: 09/991,852

(22) Filed: Nov. 16, 2001

(51) Int. Cl. B01F 3/04

(52) U.S. Cl. 261/97; 261/DIG. 3; 261/DIG. 41; 261/DIG. 43

(57) ABSTRACT

A cooler pad frame for an evaporative cooler includes an outer panel and an inner panel defining a pad space for holding a pad element. The outer panel has a plurality of louvered openings for allowing a stream of air to flow through the outer panel and into the pad element, and the inner panel has a plurality of louvered opening for allowing the stream of air to flow out of the pad element and through the inner panel. The inner panel and outer panel louvered openings have louvers projecting at an angle toward the bottom of the pad frame and inward toward the pad space. In an evaporative cooler, the pad frame is mounted to the cooler frame for holding the pad element between an air inlet and an air outlet such that the stream of air flowing through the inlet passes through the pad. A method for reducing entrainment in an evaporative cooler includes disposing a pad element in an air stream, disposing a louvered inner panel at a position downstream of the pad element and distributing water over the pad element.

### BACKGROUND

This invention relates generally to evaporative coolers. More particularly, it relates to an evaporative cooler pad frame that resists entrainment of water in the cooled air stream and an evaporative cooler employing such a pad frame.

Evaporative coolers are well known in the art and have enjoyed substantial favor over the years as devices for cooling and conditioning enclosed spaces in hot, arid regions such as the southwestern portion of the United States. Such coolers rely upon the principle that dry air forced through a medium that is wetted with water releases heat to evaporate some of that water, producing a stream of cooler, more humid air. Typically, the wetted media comprise cooling pads made of fibers of aspen or paper-based, fabricated material. As an alternative cooling system to refrigeration air conditioning, evaporative coolers consume much less energy and, as a result, have been the subject of interest in offsetting increasing costs of electrical energy associated with running an air conditioning system. The interest in evaporative cooling technology has resulted in advances in the materials employed (such as cooling pad composition), the water distribution systems, and the air movement systems, all with a goal of producing evaporative coolers that are more efficient, reliable and cost effective.

As is well known in the art, evaporative coolers typically use rotary or centrifugal blowers to draw ambient air through one or more wetted pads at a relatively high speed, or face velocity, delivering the evaporatively cooled air either directly or through a ducting system to the cooled space. It is desirable to maximize this face velocity within certain practical limits. The capacity of an evaporative cooler is measured cubic feet per minute (CFM), which is a measure of the volumetric flow rate of cooled air that the evaporative cooler delivers, and the sales price of a cooler is directly related to this capacity. For a given volumetric flow rate, the face velocity of the air flow is related to the volumetric flow rate by the formula:

Surface area of wetted medium (in square feet)×Face velocity (in feet per minute)=Volumetric flow rate (in CFM)

Thus, the CFM can be increased by increasing the surface area of the wetted medium and/or by increasing the face velocity of the air flow. Increasing the surface area of the medium, however, increases the cost of the cooler housing because that cost is directly proportional to the surface area of the wetted medium. Without increasing the cooler cabinet size, a higher face velocity is therefore required to increase the volumetric flow rate of a cooler. Conversely, to achieve a given volumetric flow rate, if one can increase in the face velocity then the surface area of the medium can be reduced, and correspondingly the cooler housing size and cost can be reduced. For these reasons, it is desirable to increase the face velocities of evaporative coolers.

Increasing the face velocity, however, presents other problems. Design standards for the face velocity of air movement through a wetted medium are specified depending on the physical characteristics of the specific material used for the wetted medium. For example, for aspen media of a defined pad density, the face velocity design standard is typically specified at 200 ft/min. When the face velocity of air movement through the wetted medium exceeds this specified design standard value, air entrains, or picks up, small droplets of the water used to wet the pads as the air passes through the pads. The entrained moisture is deposited onto the interior components of the evaporative cooler that are in the path of the cooled air, including the motor and associated wiring. This deposited moisture contributes to the corrosion and mineral deposition on the cooler components, and can result in premature failure of the components.

Entrained moisture also exits the evaporative cooler in the cooled air stream and is deposited onto the surfaces of any ducting used to transfer the cooled air. This ducting is typically formed from metal and is subject to the corrosive properties of the entrained moisture. In commercial applications where evaporative coolers are used to cool larger open areas, the coolers are typically mounted above these areas. The cooled air exits the evaporative cooler at a high velocity and travels directly into the cooled area. In such applications, entrainment can cause the deposition of small water droplets onto objects below the evaporative cooler exhaust, which can cause damage to equipment, inventory supplies and other property located in the cooled area.

Previous efforts to reduce entrainment have involved structures designed to eliminate or restrict air leakage paths that entrain moisture and carry the moisture around the pad element. U.S. Pat. Nos. 4,200,599 and 4,080,410 to Goettl disclose such structures. These structures, however, do not reduce or prevent entrainment of moisture from the pad element into the cooled air stream. Another effort to reduce entrainment involves placing a shield or shroud around the outlet for the cooled air stream to provide some protection to interior cooler parts from entrained droplets and prevent these droplets from exiting the cooler in the cooled air stream, as shown in U.S. Pat. No. 4,774,030 to Kinkel, et al. Again, this structure will not prevent or reduce entrainment of moisture at the pad frame but instead allows such entrainment, with the entrained water droplets being carried into the interior of the cooler. Moreover, the structure shown in U.S. Pat. No. 4,774,030 cannot be used in cooler configurations other than a downdraft type cooler, e.g., it cannot be used in a side draft cooler in which the conditioned air exhausts out the side of the cooler rather than the bottom.

In view of the above discussion, there exists a need in the art for an apparatus and method that substantially eliminates the entrainment of moisture into the cooled air stream of an evaporative cooler. Accordingly, it is an object of the present invention to provide such an apparatus and method.

Another object of the invention is to provide such an apparatus and method that substantially eliminates moisture deposited onto the interior components of an evaporative cooler, resulting in a more reliable evaporative cooler.

Still another object of the invention is to provide such an apparatus and method that can increase cooler capacities by increasing the air velocity limit at which entrainment will occur.

Yet another object of the invention is to provide such an apparatus that is relatively easy to manufacture and that is suitable for use with evaporative coolers of various types.

Additional objects and advantages of the invention will be set forth in the description that follows, and in part will be apparent from the description, or may be learned by practice of the invention. The objects and advantages of the invention may be realized and obtained by the instrumentalities and combinations pointed out in the appended claims.

### SUMMARY

To achieve the foregoing objects, and in accordance with the purposes of the invention as embodied and broadly described in this document, there is provided a novel cooler pad frame for an evaporative cooler. The pad frame includes means for holding a pad element in an air stream flowing from an upstream position near an outer side of the pad element to a downstream position near an inner side of the pad element. An inner panel is disposed at the downstream position. The inner panel has at least one louvered opening for allowing the air stream to flow through the inner panel. The inner panel louvered opening includes a louver projecting at an angle toward the bottom of the pad element and inward toward the pad element. The inner panel louver angle is in a range from about 40 degrees to about 60 degrees.

In one embodiment, a cooler pad frame for holding a pad for evaporatively cooling an air stream includes an outer panel and an inner panel defining a pad space for holding the pad element. The outer panel has at least one opening for allowing the stream of air to flow through the outer panel and into the pad element. The inner panel has at least one louvered opening for allowing the stream of air to flow out of the pad element and through the inner panel. The inner panel louvered opening includes a louver projecting at an angle toward the bottom of the pad frame and inward toward the pad space. Preferably, the louver angle is in a range from about 40 degrees to about 60 degrees. The outer panel opening also can be a louvered opening. The outer panel louvered opening can include a louver projecting at an angle toward the bottom of the pad frame and inward toward the pad space. In one advantageous embodiment, the outer panel louver angle and the inner panel louver angle are substantially equal. The outer panel can include a plurality of louvered openings disposed in a pattern and the inner panel can include a plurality of louvered openings disposed in a pattern that corresponds with the pattern of the inner panel louvered openings.

An evaporative cooler in accordance with the invention includes a cooler frame having an interior, an air inlet for allowing a stream of air to flow into the frame interior and an air outlet for delivering the steam of air from the interior of the frame. A cooler pad frame as described above is mounted to the cooler frame for holding a pad element between the air inlet and the air outlet such that the stream of air flowing through the inlet passes through the pad. The cooler also includes an air movement system for drawing the stream of air through the pad element and a water distribution system for distributing water over the pad element.

A method for reducing entrainment in an evaporative cooler includes disposing a pad element in an air stream flowing from an upstream position near an outer side of the pad element to a downstream position near an inner side of the pad element; disposing an inner panel at the downstream position with the inner panel having at least one louvered opening for allowing the air stream to flow through the inner panel; and distributing water over the pad element.

The apparatus and method of the invention deters the entrainment of water by incoming air. An evaporative cooler in accordance with the invention can allow increased face velocity that results in increased capacity over an identically sized evaporative cooler and operates more efficiently, reliably and cost-effectively. The interior parts of the evaporative cooler experience less water-induced corrosion, and objects in or near the evaporative cooler exhaust air flow are not subject to water damage.

### BRIEF DESCRIPTION OF THE DRAWINGS

The accompanying drawings, which are incorporated in and constitute a part of the specification, illustrate the presently preferred embodiments and methods of the invention and, together with the general description given above and the detailed description of the preferred embodiments and methods given below, serve to explain the principles of the invention.

FIG. 1 shows a partially broken perspective view of one embodiment of an evaporative cooler utilizing an entrainment resistant evaporative cooler pad frame in accordance with the invention.

FIG. 2 shows an exploded view of the entrainment resistant evaporative cooler pad frame utilized in the evaporative cooler of FIG. 1.

FIG. 3 shows a sectional elevation view of the assembled cooler pad frame of FIG. 2, taken through line 3-3.

### DESCRIPTION

Reference will now be made in more detail to the presently preferred embodiments and methods of the present invention as illustrated in the accompanying drawings, in which like numerals refer to like parts throughout the several views.

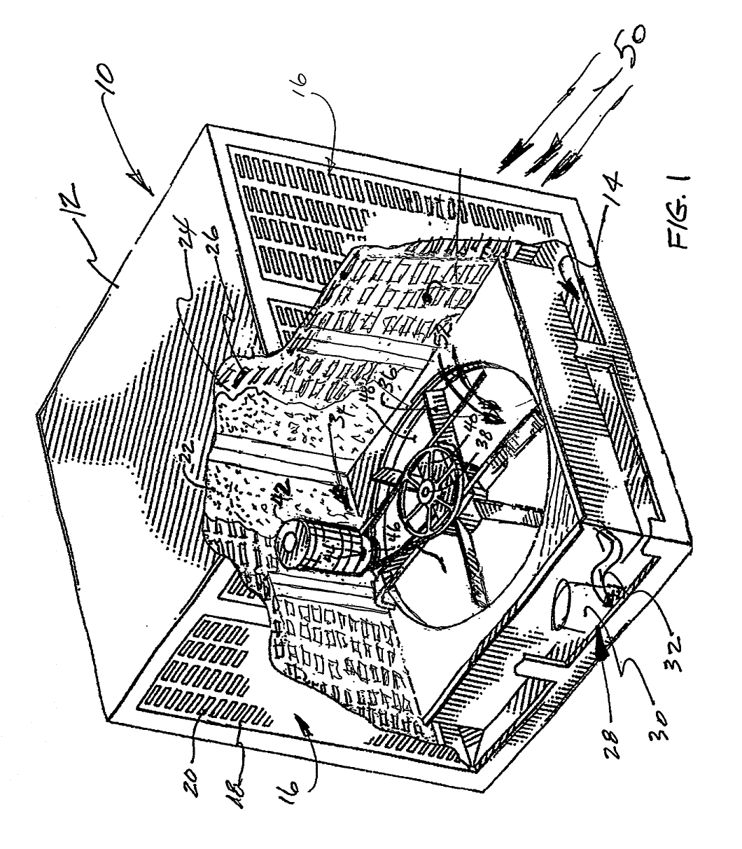

FIG. 1 illustrates an exemplary downdraft evaporative cooler 10, which includes a cooler frame 12, a water reservoir 14, pad frames 16 mounted to the cooler frame 12, a water distribution system generally indicated at 28, an air movement system generally indicated at 34, and an outlet opening 48. The pad frames 16 are mounted to the cooler frame 12 in a substantially vertical position. Each pad frame has an outer panel 18 and an inner panel 24. A pad element 22 is disposed intermediate the outer panel 18 and the inner panel 24 of each pad frame 16. The water distribution system 28 circulates water (not shown) stored in the water reservoir 14 over the pad elements 22. The air movement system 34 functions to create low pressure inside the evaporative cooler 10, drawing ambient air 50 through the pad frames 12 and across the pad element 22. Conditioned air 52, cooled by the evaporation of water from the pad element 22, exits the evaporative cooler 10 through the outlet opening 48. As previously described herein, the conditioned air 52 passes to the area to be cooled either directly or via ducting or any other suitable air distribution system.

The air movement system 34 includes a horizontally disposed fan 36 situated to discharge the conditioned air 52 substantially downward through the opening 48 and includes a central fan shaft 38, which bears a driven pulley 40. A motor 42 is vertically mounted in a position proximate the edge of the outlet opening 48. A central motor shaft 44 depends downward from the motor 42 and bears a driving pulley 46. A flexible drive belt 42 extends around the driving pulley 46 and the driven pulley 40 and couples the motor 42 to the fan 36, thereby driving the fan 36 to create the low pressure inside the evaporative cooler 10. The air movement system 34 may be implemented using a variety of other embodiments well known in the art for moving air. For example, the fan 36 may be a centrifugal blower appropriately oriented within the frame 12 as is common in the art.

The water distribution system 28 comprises a water pump 30 and distribution tubing 32 for moving water from the water reservoir 14 so that the water passes over and wets the pad elements 22. In operation, the predominant portion of the excess water not evaporated is returned to the reservoir 14. The water distribution system 28 may be implemented by any of a variety of other means that are well known in the art, and the water reservoir 14 may be formed in a variety of ways well known in the art to accommodate these means.

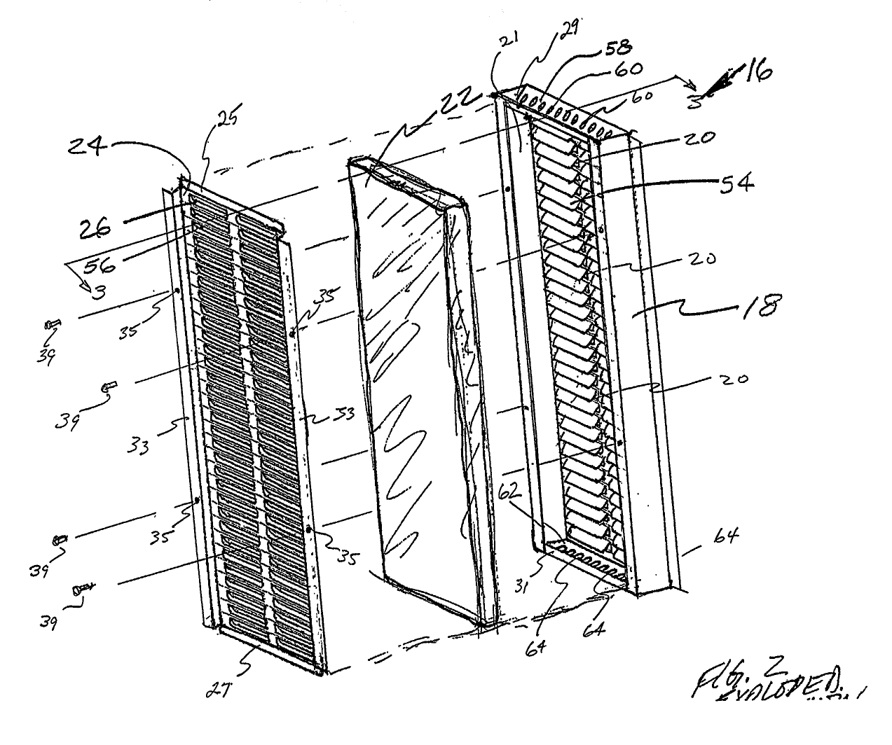

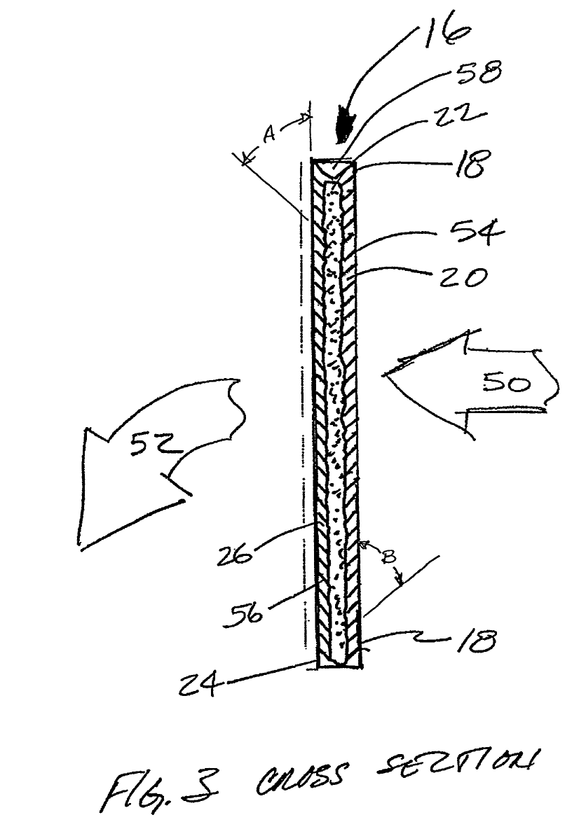

FIG. 2 and FIG. 3 illustrate the pad frame 16 and pad element 22 in more detail. When assembled, the outer panel 18 and the inner panel 24 of the pad frame 16 define a pad space for enclosing the pad element 22 and supportively holding the pad element 22 in a substantially vertical orientation without unduly compressing the pad element 22. The pad element 22 can be comprised of any evaporative cooler pad material known in the art. Suitable cooler pad materials include aspen or similar wood fibers or synthetic fibers packed together loosely to allow air to pass through. One suitable synthetic fiber is polyester fiber, such as that available from Hobbs Bonding Fibers of Grosbeck, Tex.

The outer panel 18 includes a plurality of outer panel openings 20, which permit ambient air 50 to flow in a stream substantially unrestricted through the outer panel 18 and the pad element 22. A panel louver 54 may be present for each outer panel opening 20, as is common in the art. The outer panel louver 54 extends downward and inward toward the pad element 22 at an angle B, as shown in FIG. 3. A V-shaped water distribution trough 58 runs along the top of the outer panel 18 for collecting water to be distributed through the pad element 22. Water trough openings 60 formed in the walls of the trough 58 allow water provided by the water distribution system 28 to run over and substantially throughout the pad element 22 as is known in the art. The outer panel includes a bottom 62 having return holes 64 for allowing water that reaches the bottom of the pad 22 to run out of the outer panel 18 and into to the reservoir 14. The outer panel 18 includes a space 21 for receiving the pad element 22. When assembled, the inner panel 24 is removably attached to the outer panel 18, thereby enclosing the space and retaining the pad element 22 and facilitating pad replacement. In a presently preferred embodiment, the inner panel 24 includes a top flange 25 and a bottom flange 27 and the outer panel 24 includes a top lip 29 for receiving and retaining the inner panel top flange 25 and a bottom lip 31 for receiving and retaining the inner panel bottom flange 27. The inner panel 24 also has side flanges 33 with mounting holes 35 that correspond to mounting holes 37 in the outer panel 18. The mounting holes 35, 37 are adapted for receiving mounting screws or pins 39, as are known in the art, for removably mounting the inner panel 24 to the outer panel 18.

In this configuration, the novel inner panel 24 retains the pad element 22 within the pad frame 16, thereby replacing the open wire frame pad retainer of prior art. The inner panel 24 includes a plurality of louvered inner panel openings 26, which facilitate substantially unrestricted airflow consistent with the airflow through the outer panel 18. An inner panel louver 56 is positioned to partially shield each inner panel opening 26, the inner panel louver 56 extending from the top of the inner panel opening 26 at an angle A downward and inward toward the pad element 22 at an angle A.

Referring to FIG. 3, during cooler operation, water travels from the trough 58 at the top of the pad frame 16 downward through the pad element 22. As the water travels through the pad element 22 it tends to migrate toward the inner panel 24 due to the force exerted by the airflow 50 through the pad element 22. The inner panel 24 acts as a barrier to keep the water from being entrained in the conditioned air 52. The inner panel louvers 56 further inhibit entrainment by collecting and redirecting the water back into the pad element 22. The inner panel louver angle A is selected from a range of about 40 degrees to about 60 degrees. In one advantageous embodiment, the louver angle A of the inner panel louvers 56 is about 45 degrees.

The outer panel 18 and the inner panel 24 are preferably constructed of rugged, weather-resistant material, such as epoxy-coated or water-resistant painted metal, or high-impact plastic, but may be constructed of any other material known in the art. In one advantageous embodiment, the outer panel openings 20 and louvers 54 are formed in a pattern that corresponds with the inner panel openings 26 and louvers 56, i.e. the inner panel openings 26 are the same in size and shape as the outer panel openings 20 and the inner panel louvers 56 are the same in size, shape and louver angle as the outer panel louvers 54, although the inner panel louvers 56 and the outer panel louvers 54 project inwardly in opposing directions. This embodiment facilitates a lower tooling cost for the manufacture of the panels by allowing the same tool to produce the openings and louvers in both parts. For example, if the panels 18, 24 are constructed of sheet metal, different sheet metal blank sizes can be used for each panel, the edges of the panels can be roll-formed using a conventional roll former and a single simple stamping die former can be used to form the openings 20, 26 and the louvers 54, 56 in both the inner panel 24 and the outer panel 18.

As will be apparent to those of ordinary skill in the art, the invention is not limited to use with an evaporative cooler of the downdraft type, as shown in FIG. 1. Rather, the evaporative cooler 10 may be any of a variety of configuration known in the art. For example, the cooler may be a side draft version in which the conditioned air 52 exhausts out the side of the cooler rather than the bottom. To name just a few other configurations, the evaporative cooler 10 may be of singular or multiple pad design or may be portable or fixed in nature. The evaporative cooler 10 may be constructed of any of a variety of rugged, weather-resistant materials well known in the art, including epoxy-coated or water-resistant painted metal, or high-impact plastic.

A prototype pad frame has been constructed using the pad frame embodiment shown in FIGS. 2 and 3. Testing of this prototype versus a pad frame of the same size using the same pad element and a conventional wire retainer has demonstrated that the pad frame of the present invention can realize an increase in non-entrainment pad velocity of about 15% with negligible increase in static air pressure resistance.

From the foregoing, it can be seen that the apparatus and method of the invention pad frame possess a number of advantages. They can eliminate the entrainment of water into the conditioned air for an existing evaporative cooler design and provide increased cooler capacity for new or modified coolers by allowing an increase in air velocity without the entrainment that would result using existing pad frames. The interior parts of an evaporative cooler in accordance with the invention are subject to less damage. The ducting used to distribute the conditioned air of an evaporative cooler in accordance with the invention is not subject to entrainment-induced corrosion. Similarly, an entrainment resistant pad frame in accordance with the invention eliminates water damage to objects near or below the exhaust of evaporative coolers which employ the pad frame. Overall, the apparatus and method of the invention provide for more efficient, cost-effective and reliable evaporative coolers.

While certain preferred embodiments and methods of the invention have been described, these have been presented by way of example only, and are not intended to limit the scope of the present invention. Additional advantages and modifications will readily occur to those skilled in the art. Therefore, the invention in its broader aspects is not limited to the specific embodiments, methods and conditions described herein, which are not meant to and should not be construed to limit the scope of the invention. Accordingly, departures may be made from such embodiments and methods, variations may be made from such conditions, and deviations may be made from the details described herein without departing from the spirit or scope of the general inventive concept as defined by the appended claims and their equivalents.

What is claimed is;

1. A cooler pad frame for holding a pad element for evaporatively cooling a stream of air, the pad frame comprising:
an outer panel and an inner panel defining a pad space for holding the pad element;
the outer panel having at least one opening for allowing the stream of air to flow through the outer panel and into the pad element; and
the inner panel having a plurality of louvered openings including a louver projecting at a louver angle downward toward the bottom of the pad frame and inward toward the pad space for allowing the stream of air to flow out of the pad element and through the inner panel.

2. The cooler pad frame of claim 1 wherein the louver angle is in a range from about 40 degrees to about 60 degrees.

3. The cooler pad frame of claim 1 wherein the at least one outer panel opening is a louvered opening.

4. The cooler pad frame of claim 3 wherein the at least one outer panel louvered opening includes a louver projecting at an angle toward the bottom of the pad frame and inward toward the pad space.

5. The cooler pad frame of claim 4 wherein the outer panel louver angle and the inner panel louver angle are substantially equal.

6. The cooler frame of claim 3 wherein the outer panel includes a plurality of louvered openings disposed in a pattern and the inner panel includes a plurality of louvered openings disposed in a pattern that corresponds with the pattern of the inner panel louvered openings.

7. An evaporative cooler comprising:
a cooler frame having an interior, an air inlet for allowing a stream of air to flow into the frame interior and an air outlet for delivering the stream of air from the interior of the frame;
a cooler pad frame mounted to the cooler frame for holding a pad element between the air inlet and the air outlet such that the stream of air flowing through the inlet passes through the pad, the cooler pad frame including an inner panel and an outer panel;
the inner panel having at least one louvered opening for allowing the stream of air to flow through the inner panel, the inner panel louvered opening including a louver projecting at an angle toward the bottom of the pad frame and inward toward the pad space; and
the outer panel having at least one outer panel opening; and
an air movement system for drawing the stream of air through the pad element; and
a water distribution system for distributing water over the pad element.

8. The evaporative cooler of claim 7 wherein the inner panel louver angle is in a range from about 40 degrees to about 60 degrees.

9. The evaporative cooler of claim 7 wherein the at least one outer panel opening is a louvered opening.

10. The evaporative cooler of claim 9 wherein the at least one outer panel louvered opening includes a louver projecting at an angle downward toward the bottom of the pad frame and inward toward the pad space.

11. The evaporative cooler of claim 10 wherein the outer panel louver angle and the inner panel louver angle are substantially equal.

12. The evaporative cooler of claim 9 wherein the outer panel includes a plurality of louvered openings disposed in a pattern and the inner panel includes a plurality of louvered openings disposed in a pattern that corresponds with the pattern of the inner panel louvered openings.

13. A cooler pad frame for an evaporative cooler, the pad frame comprising:
means for holding a pad element in an air stream flowing from an upstream position near an outer side of the pad element to a downstream position near an inner side of the pad element; and
an inner panel disposed at the downstream position, the inner panel having at least one louvered opening for allowing the air stream to flow through the inner panel.

14. The cooler pad frame of claim 13 wherein the at least one inner panel louvered opening includes a louver projecting at an angle toward the bottom of the pad element and inward toward the pad element.

15. The evaporative cooler of claim 14 wherein the inner panel louver angle is in a range from about 40 degrees to about 60 degrees.

16. A method for reducing entrainment in an evaporative cooler, the method comprising:
disposing a pad element in an air stream flowing from an upstream position near an outer side of the pad element to a downstream position near an inner side of the pad element;
disposing an inner panel at the downstream position, the inner panel having at least one louvered opening for allowing the air stream to flow through the inner panel; and
distributing water over the pad element. The method of reducing entrainment according to claim 15 wherein the step of disposing an inner panel at the downstream position further comprises disposing an inner panel having a plurality of louvered openings having a louver projecting at an angle downward toward the bottom of the pad element and inward toward the pad element.

18. The cooler pad frame of claim 2 wherein the louver angle is about 45 degrees.

19. The evaporative cooler of claim 8 wherein the louver angle is about 45 degrees.

20. The evaporative cooler of claim 15 wherein the louver angle is about 45 degrees.
